(19) United States
(12) Patent Application Publication
(10) Pub. No.: US 2022/0246944 A1
(43) Pub. Date: Aug. 4, 2022

(54) ELECTRODE FOR LITHIUM ION SECONDARY BATTERY, AND LITHIUM ION SECONDARY BATTERY

(71) Applicant: HONDA MOTOR CO., LTD., Tokyo (JP)

(72) Inventors: Kiyoshi TANAAMI, Saitama (JP); Toshimitsu TANAKA, Saitama (JP); Yuji ISOGAI, Saitama (JP); Masahiro OHTA, Saitama (JP); Takuya TANIUCHI, Saitama (JP)

(21) Appl. No.: 17/581,860

(22) Filed: Jan. 22, 2022

(30) Foreign Application Priority Data
Jan. 29, 2021 (JP) 2021-012761

(51) Int. Cl. H01M 4/76; H01M 4/36

(52) U.S. Cl. CPC H01M 4/762; H01M 2004/021; H01M 4/364

(57) ABSTRACT

Provided is an electrode for lithium ion secondary batteries in which an electrode material mixture is packed in porous metal, which electrode has excellent penetration of electrolyte solution and improved ion diffusivity. The electrode for lithium ion secondary batteries includes a current collector made of porous metal; and an electrode layer including an electrode material mixture including at least an electrode active material, in which the current collector is filled with the electrode material mixture, the current collector has an intermediate region and two surface regions in its thickness direction and m the electrode layer, the intermediate region has a porosity lower than that of the two surface region, and the intermediate region is filled with a first electrode active material, and the two surface regions are filled with a second electrode active material having a particle size larger than that of the first electrode active material.

This application is based on and claims the benefit of priority from Japanese Patent Application No. 2021-012761, filed on 25 Jan. 2021, the content of which is incorporated herein by reference.

### BACKGROUND OF THE INVENTION

### Field of the Invention

The present invention relates to an electrode for lithium ion secondary batteries, and a lithium ion secondary battery using such electrode for lithium ion secondary batteries.

### Related Art

Lithium ion secondary batteries have been widely used as secondary batteries having high energy density so far. Lithium ion secondary batteries have a structure in which a separator exists between positive electrode and negative electrode and a liquid electrolyte (electrolyte solution) is packed.

There are various requests for such lithium ion secondary batteries depending on applications, and, for example, when applied to e.g., vehicles, it is required to further increase volume energy density. In order to do this, the packing density of an electrode active material is increased.

As the method for increasing the packing density of an electrode active material, it is proposed to use porous metal such as metal foam as current collectors to make a positive electrode layer and a negative electrode layer (e.g., see Patent Document 1). The porous metal has a network structure and a large surface area. The amount of an active material per unit area of an electrode layer can be increased by packing an electrode material mixture including an electrode active material in the inside of the network structure.

Meanwhile, in order to display high capacity and excellent cycle characteristics, the constitution of an electrode obtained by packing an electrode material mixture containing two types of electrode active materials with different particle sizes in porous metal of an identical pole is also disclosed (e.g., see Patent Document 2).

Patent Document 1: Japanese Unexamined Patent Application, Publication No. H07-099058

Patent Document 2: Japanese Unexamined Patent Application, Publication No. 2012-033260

### SUMMARY OF THE INVENTION

From on electrode using porous metal as a current collector described in Patent Document 1, an electrode having a higher basis weight than of a coated electrode using metal foil as a current collector can be produced; however, the film thereof becomes thicker. Because of this, the transfer distance of electron and lithium ion becomes longer, ion diffusion resistance increases, and rate characteristics are reduced.

In addition, when the film becomes thicker, the penetration properties of an electrolyte solution is reduced, and thus the penetration of the electrolyte solution into the inside of an electrode becomes insufficient. Therefore, the supply of anion and cation is insufficient, and thus the internal resistance of a lithium ion secondary battery cell formed increases and output and input characteristics (output density) of the battery are reduced.

The present invention was made in view of the above, and an object thereof is to provide an electrode for lithium ion secondary batteries in which an electrode material mixture is packed in porous metal, which electrode has excellent penetration of electrolyte solution and improved ion diffusivity, and a lithium ion secondary battery using the same.

The present inventors diligently investigated to solve the above problems. The present inventors found that the above problems could be solved by, in an electrode layer of an electrode for lithium ion secondary batteries using a current collector obtained from porous metal, changing the particle sizes of electrode active materials in the thickness direction of the electrode layer, and also changing the porosity of the current collector in the same manner, thereby completing the present invention. Specifically, the present invention provides the following.

(1) An electrode for lithium ion secondary batteries, the electrode including: a current collector made of porous metal; and an electrode layer including an electrode material mixture including at least an electrode active material, the current collector being filled with the electrode material mixture, the current collector having an intermediate region and two surface regions in its thickness direction and in the electrode layer, the intermediate region having a porosity lower than that of the two surface regions, the intermediate region being filled with a first electrode active material, the two surface regions being filled with a second electrode active material having a particle size larger than that of the first electrode active material.

According to the invention in (1), a current collector is formed so that the porosity In the thickness direction will be large/small/large in the order of surface region/intermediate region/surface region (back region), and electrode active materials with different particle sizes are packed therein so that the particle size will be large/small/large. Because of this, ion conducting channels from both surface regions are obtained to ensure that an electrolyte solution can be infiltrated into the intermediate region.

(2) The electrode for lithium ion secondary batteries according to (1), wherein the intermediate region has an electrode active material filling density higher than that of the two surface regions.

According to the invention in (2), when the packing density of the electrode active material is larger in the intermediate region than in both the surface regions, the (1) effect can be further increased.

(3) A lithium ion secondary battery, including a positive electrode, a negative electrode, and a separator located between the positive electrode and the negative electrode, at least one of the positive electrode and the negative electrode being the electrode according to (1) or (2).

According to the invention in (3), a lithium ion secondary battery displaying the effects of (1) and (2) is obtained.

(4) A method for producing an electrode for lithium ion secondary batteries, the method including: a first step Including forming a current collector that is made of porous metal and has an intermediate region and two surface regions in its thickness direction, wherein the intermediate region has a porosity lower than that of the two surface regions; and a second step including filling the intermediate region of the current collector with an electrode material mixture including a first electrode active material and filling the two surface regions of the current collector with an electrode material mixture including a second electrode active material with a particle size larger than of that of the first electrode active material.

According to the invention of the production method in (4), a lithium ion secondary battery displaying the effects of (1) to (3) is obtained.

(5) The method for producin3 an electrode for lithium ion secondary batteries according to (4), wherein an electrode material mixture containing the first electrode active material and the second electrode active material is applied to each of sides of the two surface regions of the current collector and filled in the current; collector.

According to the invention of the production method in (5), when an electrode material mixture containing a first electrode active material and a second electrode active material is packed by coating from each of both the surface region sides, the filtering effect occurs due to changes in the porosity in the thickness direction of a current collector, a first electrode active material with a relatively smaller particle size is packed in the intermediate region, and a second electrode active material with a relatively larger particle size is packed in both the surface regions.

According to the electrode for lithium ion secondary batteries of the present invention, it is possible to provide an electrode for lithium ion secondary batteries in which an electrode material mixture is packed in porous metal, which electrode has excellent penetration of electrolyte solution and improved ion diffusivity, and a lithium ion secondary battery using the same.

### BRIEF DESCRIPTION OF THE DRAWINGS

FIG. 1 is a schematic exploded perspective view which shows an embodiment of the electrode for lithium ion secondary batteries of the present invention;

FIG. 2 is a conceptual diagram which shows an embodiment of the electrode for lithium ion secondary batteries of the present invention;

FIG. 3 is a conceptual diagram which shows an example of the method for producing an electrode for lithium ion secondary batteries of the present invention;

FIG. 4 is a graph which shows cell resistance, initial characteristics, measured in Examples;

FIG. 5 is a graph which shows capacity retention rates, initial characteristics, measured in Examples;

FIG. 6 is a graph which shows post-durability capacity retention rates measured in Examples; and

FIG. 7 is a graph which shows post-durability resistance change rates measured in Examples.

### DETAILED DESCRIPTION OF THE INVENTION

An embodiment of the present invention will now be described with reference to the drawings. The contents of the present invention are not limited to descriptions of the following embodiment. The electrode for lithium ion secondary batteries of the present invention can be applied to a positive electrode, a negative electrode or. both the electrodes in a lithium ion secondary battery. It should be noted that the following embodiment is described using a lithium Ion battery having a .liquid electrolyte as an example; however, the present invention is not limited thereto and can be also applied to .secondary batteries with a solid electrolyte. The present invention can be also applied to batteries other than lithium ion batteries.

### <Whole Constitution of Lithium Ion Secondary Battery>

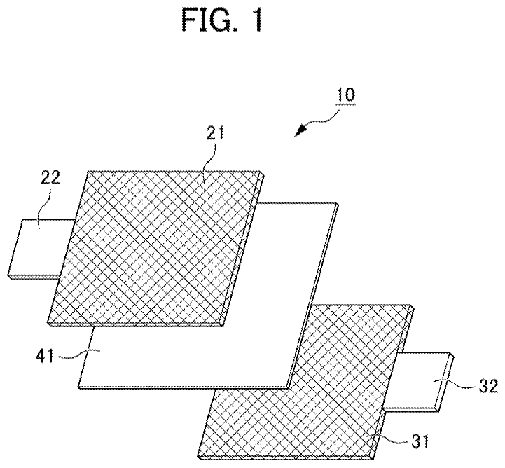

As shown in FIG. 1, the positive electrode layer 21 and the negative electrode layer 31, electrodes for a lithium ion secondary battery, are laminated with the separator 41 put therebetween in this lithium ion secondary battery 10. An electrolyte solution, not shown, is arranged between respective layers to make the lithium ion secondary battery 10. The positive electrode tab 22 is extended from the positive electrode layer 21 for current collection, and the negative electrode tab 32 is extended from the negative electrode layer 31 for current collection. The positive electrode is formed by the positive electrode layer 21 in the present invention, and the negative electrode is formed by the negative electrode layer 31 in the present invention. The structure of the electrode for lithium ion secondary batteries of the present invention is not particularly limited and may be a laminated type or a wound type.

An optional battery can be made by selecting two types of materials from those which can make an electrode, comparing charge and discharge potentials in the two types of compounds, and using a compound showing a nobler potential as a positive electrode and a compound showing a lower potential as a negative electrode. Any number of single cells of positive electrode/electrolyte/negative electrode are laminated to make a lithium ion secondary battery.

### [Electrolyte]

The electrolyte is a liquid electrolyte solution in which an electrolyte is dissolved in a nonaqueous solvent. The electrolyte dissolved in a nonaqueous solvent is not particularly limited, and examples thereof can include LiPF₆, LiBF₄, LiClO₄, LiN(SO₂CF₃), LiN(SO₂C₂F₅)₂, LiCF₃SO₃, LiC₄F₃SO₃, LiC(SO₂CF₃)₃, LiF, LiCl, LiI, Li₂S, Li₃N, Li₃P, Li₁₀GeP₂S₁₂ (LGPS), Li₃P$₄, Li₆P$₅Cl, Li₇P₂S₈I, LiₓPO_{y}N_{z} (x=2y+3z−5, LiPON), Li₇La₃Zr₂O₁₂ (LLZO), Li₃ₓLa_{2/3-x}TiO₃ (LLTO), Li₁₊ₓAlₓTi₂₋ₓ (PO₄)₃ (0≤x≤1, LATP), Li_{1.5}Al_{0.5},Ge_{1.5}(PO₄)₃(LAGP), Li_{1+x+y}AlₓTi₂₋ₓSiyP_{3+y}O₁₂, Li_{1+x+y}Alₓ(Ti, Ge)₂₋ₓSiyP_{3-y}O₁₂, Li₄₋₂ₓZnₓGeO₄ (LISICON) and the like. The above may be used individually or two or more of the above may be used in combination.

The nonaqueous solvent included in the electrolyte solution is not particularly United, and examples thereof can include aprotic solvents such as carbonates, esters, ethers, nitriles, sulfones, and lactones. Specific examples thereof can include ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyl tetrahydrofuran, dioxane, 1,3-d:oxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, g-butyrolactone and the like. The above may be used individually or two or more of the above may be used in combination.

### [Separator]

The lithium ion secondary battery of the present invention may include a separator when a liquid electrolyte is used. The separator is located between the positive electrode and negative electrode. The material and thickness thereof, for example, are not particularly limited, and known separators which can be used for lithium ion secondary batteries such as polyethylene and polypropylene can be applied.

When a solid electrolyte layer is used in a solid battery, the solid electrolyte is not particularly limited, and examples thereof can include sulfide-based solid electrolyte materials, oxide-based solid electrolyte materials, nitride-based solid electrolyte materials, halide-based solid electrolyte materials and the like. In the case of lithium ion batteries, examples of sulfide-based solid electrolyte materials include LPS halogen (Cl, Br, I), Li₂S—P₂S₄, Li₂S—P₂S₅—LiI and the like. It should be noted that the description of the above “Li₂S—P₂S₅” means a sulfide-based solid electrolyte material obtained by using a material composition including Li₂S and P₂S₅, and the same applies to the other descriptions. In the case of lithium ion batteries, examples of oxide-based solid electrolyte materials can include NASICON-type oxides, garnet-type oxides, perovskite-type oxides and the like. Examples of NAS ICON-type o/.ides can include oxides containing Li, Al, Ti, P and O (e.g., Li_{1.5}Al_{0.5}Ti_{1.5}(PO₄)₃). Examples of garnet-type oxides can include oxides containing Li, La, 2r and O (e.g., Li₇La₃Zr₂O₁₂). Examples of perovskite-type oxides can include oxides containing Li, La, Ti and O (e.g., LiLaTiO₃).

### [Constitution of Electrode Layer]

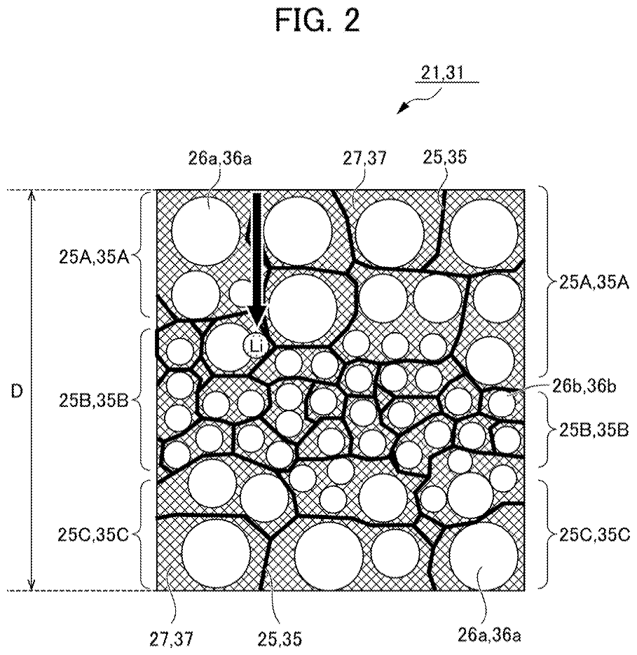

The electrode layer, a feature of the present invention, will now be described. As shown in the schematic cross-section view in FIG. 2, the positive electrode layer 21 and negative electrode layer 31 have planar current collectors 25 and 35, respectively, made of porous metal having continuous pores to each other (communicating pores). A positive electrode material mixture 27 including a positive electrode active material 26, and a negative electrode material mixture 37 including a negative electrode active material 36 are packed and arranged in the pores of the current collectors 25 and 35, respectively. It should be noted that in FIG. 2, an example of the positive electrode layer 21 is shown, and because the negative electrode layer 31 has the same constitution, only parenthesized signs are shown, in the view, the D direction is the thickness direction.

### [Current Collector]

As the current collectors 25 and 35, current collectors, porous metal obtained from metal, are used. A mesh, a woven fabric, a non-woven fabric, an embossed metal, a punched metal, an expanded metal, a foam and the like are shown as examples, and a metal foam is preferably used. Among these, a metal foam having a three dimensional network structure with continuous pores is preferably used, and for example CELMET (registered trademark) (manufactured by Sumitomo Electric Industries, Ltd.) and the like can be used.

Porous metal has a network structure and a large surface area. Because an electrode material mixture including an electrode active material can be packed in the inside of such network structure by using porous metal obtained from metal as a current collector, the amount of an active material per unit area of an electrode layer can be increased, and consequently the volume energy density of a lithium ion secondary battery can be improved.

In addition, because the immobilization of the electrode material mixture becomes easy, it is not required to increase the viscosity of coating slurry, which is the electrode material mixture, and an electrode material mixture layer can be thicker. The amount of a binding agent including an organic polymer compound, which has been required for viscosity increase, can be also reduced.

Therefore, the electrode material mixture layer can be thick compared to conventional electrodes using metal foil as a current collector, and consequently the capacity per unit area of an electrode can be increased, and the higher capacity of a lithium ion secondary battery can be achieved.

In this embodiment, the current collectors 25 and 35 are continuous in the thickness direction, and have, in the thickness direction, at least the surface regions including both surfaces, and the intermediate region located between the two surface regions. In this embodiment, specifically, the current collectors 25 and 35 are formed by the intermediate regions 258 and 35B, surface regions 25A and 35A and surface regions (back regions) 25C and 35C, and the porosity thereof is different. It should be noted that the thickness direction means the out-of-plane direction of a planar current collector. That is, the current collector has three layers, surface region 25A/intermediate region 25B/surface region (back region) 25C, or surface region 35A/intermediate region 35B/surface region (back region) 35C, and the porosity is larger in the surface regions than in the intermediate region. It should be noted that the intermediate regions 25B and 35B are arranged in the almost intermediate part in the thickness direction.

In the present Invention, both the surface regions and the intermediate region may be one consecutive current collector as described above, or one in which a plurality of current collectors, each having a region, are joined.

Because the porosity is different between the intermediate region and both the surface regions in a current collector, when an electrode material mixture including at least an electrode active material is packed in pores in the current collector, the filter effect occurs, and electrode active material particles with a larger particle size remain in both the surface regions, and electrode active material particles with a smaller particle size are easily packed in the intermediate region of the current collector.

The intermediate regions 25B and 35B are preferably arranged in 20% or more and 80% or less to the thickness D of an electrode layer as described below.

The average porosity of the whole porous metal is preferably 90 to 99%. When the average porosity of porous metal is within this range, the amount of an electrode material mixture packed can be increased, and the energy density of a battery is improved. Specifically, when the average porosity is above 99%, the mechanical strength of porous metal is significantly reduced, and the porous metal is easily broken by changes in the volume of an electrode with charge and discharge. Conversely, when the average porosity is less than 90%, not only the amount of an electrode material mixture packed is reduced, but also the ion conductivity of an electrode is reduced, and thus it is difficult to obtain sufficient input and output characteristics. From these viewpoints, the average porosity is more preferably 93 to 98%. It should be noted that because there are differences in porosity between the surface regions and the intermediate region in the current collector of the present invention, the average porosity is the porosity of the whole current collector to make an electrode layer. It should be noted that the above porosity is (pore space volume)/(whole porous metal volume) of porous metal in the state before forming an electrode layer, and is calculated by measuring volume and mass and using the ratio to the true density of metal.

From the viewpoint of certainly obtaining the filtering effect, the porosity of porous metal in the intermediate regions 25B and 35B is preferably 93% or more and 95% or less, and the porosity in the surface regions 25A, 35A, 25C and 35C is preferably 95% or more and 98% or less.

The average pore diameter of porous metal in an electrode layer is preferably 500 mm or less. When the average pore diameter of porous metal is within this range, a distance between the negative electrode active material packed in the inside of porous metal and the metal skeleton becomes stable, and electron conductivity is improved to suppress an increase in the internal resistance of a battery. In addition, even when volume changes occur with charge and discharge, falling of an electrode material mixture can be suppressed. It should be noted that the above average pore diameter is the median diameter (d50) value measured by the mercury intrusion porosimetry method.

The specific surface area of porous metal is preferably 1000 to 10000 m²/m³. This is twice to 10 times larger than the specific surface area of conventionally common current collector foil. When the specific surface area of porous metal is within this range, the contact properties of an electrode material mixture and a current collector are improved and an increase in the internal resistance of a battery is suppressed. The specific surface area is more preferably 4000 to 7000 m²/m³.

Examples of metal of porous metal obtained from metal Include nickel, aluminum, stainless, titanium, copper, silver, a nickel-chromium alloy and the like. Among these, foamed aluminum is preferred as a current collector to make a positive electrode, and foamed copper and foamed stainless are preferably used as a current collector to make a negative electrode.

### [Electrode Layer]

The electrode layer in the electrode for lithium ion secondary batteries of the present embodiment is the one obtained by packing an electrode material mixture in a current collector, porous metal obtained from metal.

The thickness of the electrode layer is not particularly limited; however, because porous metal obtained from metal is used as a current collector in the electrode for lithium ion secondary batteries of the present invention, a thicker electrode layer can be formed. Consequently, the amount of an active material per unit area of the electrode layer is increased, and a battery with high energy density can be obtained.

The thickness D of the electrode layer in the electrode for lithium ion secondary batteries of the present invention is, for example, 200 to 500 mm.

### [Electrode Material Mixture]

An electrode material mixture to make the electrode layer of the present invention includes at least an electrode active material. The electrode material mixture, which can be applied to the present invention, may optionally include other components as long as it includes an electrode active material as an essential component. Other components are not particularly limited, and may be components which can be used when producing a lithium ion secondary battery. Examples thereof include a solid electrolyte, a conductive additive, a binding agent and the like.

### (Positive Electrode Material Mixture)

In a positive electrode material mixture to make a positive electrode layer, at least a positive electrode active material is Contained, and, for example, a solid electrolyte, a conductive additive, a binding agent and the like may be contained as other components. The positive electrode active material is not particularly limited as long as it can absorb and release lithium ion, and examples thereof can include LiCoO₂, Li(Ni_{5/10}Co_{2/10}Mn_{3/10})O₂, Li(Ni_{6/10}CO_{2/10}Mn_{2/10})O₂, Li(Ni_{8/10}Co_{1/10}Mn_{1/10})O₁, Li(Ni_{0.8}CO_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, and the like.

### (Negative Electrode Material Mixture)

In a negative electrode material mixture to make a negative electrode layer, at least a negative electrode active material is contained, and, for example, a solid electrolyte, a conductive additive, a binding agent and the like may be contained as other components. The negative electrode active material is not particularly United as long as it can absorb and release lithium ion, and examples thereof can include lithium metal, a lithium alloy, a metal oxide, a metal sulfide, a metal nitride. Si, SiO, carbon materials such as artificial graphite, natural graphite, hard carbon and soft carbon and the like.

### (Other Components)

The electrode material mixture may optionally include other components other than the electrode active material. Other components are not particularly limited, and may be components which can be used when producing a lithium ion secondary battery. Examples thereof include a conductive additive, a binding agent and the like. As conductive additives for positive electrodes, acetylene black and the like can be shown as examples, and as binders for positive electrodes, polyvinylidene difluoride and the like can be shown as examples. As binders for negative electrodes, sodium carboxymethyl cellulose, styrene butadiene rubber, sodium polyacrylate and the like can be shown as examples.

### (Particle Size of Electrode Active Material)

The first electrode active materials 26a and 36a are packed in the intermediate regions 25B and 35B, and the second electrode active materials 26b and 36b are packed in both the surface regions 25A, 35A, 25C and 35C. The particle size of the second electrode active material is larger than of the first electrode active material.

Specifically, the particle size of the first electrode active materials 26a and 36a is preferably 3 mm or more and less than 7 mm as the median diameter (D50), and the particle size of the second electrode active materials 26b and 36b is preferably 7 mm or more and 15 mm or less as the median diameter (D50). Because of this, ion conducting channels from both the surface regions are obtained, and an electrolyte solution can be certainly infiltrated into the intermediate region.

### (Packing Density of Electrode Active Material)

In the electrode layers 21 and 31, the packing density of an electrode active material in the intermediate region is preferably larger than the packing density of an electrode active material in the surface regions. Specifically, in the positive electrode, the packing density of an electrode active material in the intermediate region is preferably 2.6 to 3.8 g/cm³, and the packing density cf an electrode active material in the surface regions is preferably 2.0 to 2.8 g/cm³. In the negative electrode, the packing density of an electrode active material in the intermediate region is preferably 1.0 to 2.0 g/cm⁵, and the packing density of an electrode active material in the surface regions is preferably 0.5 to 2.0 g/cm³.

### <Method for Producing Electrode Layer>

### (First Step)

In the first step, planar current collectors 25 and 35 made of porous metal are formed, in which the porosity of the intermediate region in the thickness direction is smaller than the porosity of both the surface regions. In this step, it is only required to produce current collectors in the intermediate region and the surface regions, having different porosity, in advance, and to laminate these by joining in the form of layer.

### (Second Step)

In the second step, an electrode material mixture including a first electrode active material is packed in the intermediate region of the current collector, and an electrode material mixture including a second electrode active material with a larger particle sire than of the first electrode active material is packed in both the surface regions of the current collector.

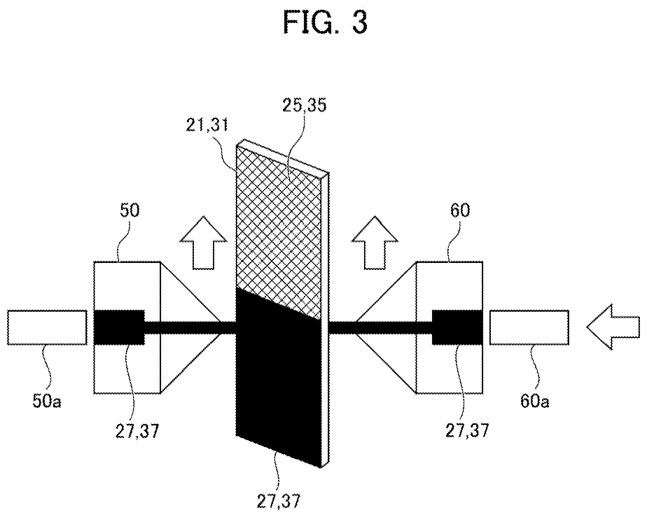

As shown In FIG. 3, the positive electrode materiel mixture 27 and the negative electrode material mixture 37 containing the first electrode active material and the second electrode active material is packed by coating from each of both the surface region sides of the current collector. In the example shown In FIG. 3, the positive electrode material mixture 27 and the negative electrode material mixture 37 are made into slurry, and using the die coaters 50 and 60 the slurry is then discharged from dies by pushing the slurry with the plunger 50a of the die coater 50 and the plunger 60a of the die coater 60 to apply the electrode material mixture in the form of surface from both the surfaces of the current collector. An electrode layer can be formed by packing the slurry including the electrode material mixture in the inside of the current collector network structure.

At this time, there are a method for packing an electrode material mixture at one time from both surfaces, an optional surface of a current collector and the surface opposite thereto, and a method for packing an electrode material mixture in surfaces, an optional surface and the surface opposite thereto, in turn; however, it is preferred to use the method for packing an electrode material mixture at one time from both the surfaces, an optional surface of a current collector and the surface opposite thereto, as shown in FIG. 3.

As the electrode material mixture, an electrode material mixture containing both the first electrode active material and second electrode active material can be packed. That is, it is only required to pack an electrode material mixture including electrode active material particles with a plurality of peaks in the particle size distribution. By packing it in a current collector after the above first step, the filtering effect occurs due to differences in the porosity of the current collector, and an electrode material mixture including a second electrode active material with a relatively larger particle size is packed in both the surface regions of the current collector, and a first electrode active material with a relatively smaller particle size is packed in the intermediate region.

It should be noted that the present invention is not limited to the above, and an electrode material mixture containing a first electrode active material is packed in a current collector to make the intermediate region, separately an electrode material mixture containing a second electrode active material is packed in a current collector to make both the surface regions, and the electrode layer of the present invention may be then obtained by joining both the current collectors.

It should be noted that the method for packing an electrode material mixture is not limited to the die coating method, and a dipping method by dipping of an electrode material mixture and the like can be also used.

### <Method for Producing Lithium Ion Secondary Battery>

The method for producing a lithium ion secondary battery of the present invention using the above electrode layer is not particularly limited, and a common method in the art can be applied. After packing an electrode material mixture, the electrode for lithium ion secondary batteries of the present embodiment can be obtained by joining electrode layers to each other with an electrolyte put therebetween as shown in FIG. 1. As the method for joining electrode layers to each other, a common method in the art can be applied. For example, a current collector packed with an electrode material mixture is dried and then pressed to obtain an electrode for lithium ion secondary batteries. The density of the electrode material mixture can be improved by pressing and can be adjusted to obtain a desired density.

As described above, by the electrode for lithium ion secondary batteries and the lithium ion secondary battery using the same of the present invention, even when an electrode layer is thick, an electrolyte solution can be penetrated into the middle region in the thickness direction. Because the ion transfer distance in an electrode can be shorter, an increase in ion diffusion resistance can be suppressed, and consequently, durability such as rate characteristics can be improved. In particular, ion can be rapidly provided even under high load such as rapid charge and discharge, and thus the present invention can contribute to improvements in durability under high load environments.

Furthermore, even when the electrode layer is thick, a lack of supply of electron can be suppressed, and thus an increase in electronic resistance can be suppressed and the output characteristics of a lithium ion secondary battery can be improved.

### EXAMPLES

The present invention will now be described in more detail by way of examples thereof. It should be noted, however, that the present invention is not United thereto.

### Example 1

### [Production of Positive Electrode]

### (Positive Electrode Current Collector)

Foamed aluminum with a thickness of 0.5 mm and a porosity of 95% was prepared as a positive electrode current collector in the intermediate region. Foamed aluminum with a thickness of 0.5 mm and a porosity of 97% was prepared as a positive electrode current collector in the surface regions. The current collector in the intermediate region was put between the positive electrode current collectors in the surface regions, and these were joined by roll pressing at a linear pressure of 0.1 ton/cm.

### (Production of Positive Electrode Material Mixture Slurry)

LiNi_{0.5}Co_{0.2}Mn_{0.3}O₂ with a median diameter (D50) of 5 mm was prepared as a positive electrode active material for the intermediate region. LiNi_{0.5}Co_{0.2}Mn_{0.3}O₂ with a median diameter (D50) of 12 mm was prepared as a positive electrode active material for the surface regions. After mixing 47 masse of the positive electrode active material with D50=5 mm, 47 mass % of the positive electrode active material with D50=12 mm, 4 mass % of acetylene black as a conductive additive and 2 mass % of polyvinylidene difluoride (PVDF) as a binding agent, the obtained mixture was dispersed m an appropriate amount of N-methyl-2-pyrrolidone (NMP) to produce positive electrode material mixture slurry.

### (Packing of Positive Electrode Material Mixture)

The positive electrode material mixture slurry was applied to the positive electrode current collector using a plunger-type die coater so that the coated amount was 100 mg/cm², and then dried at 120° C. for 12 hours under vacuum conditions. Next, the positive electrode current collector packed with the positive electrode material mixture was roll-pressed at a pressure of 15 ton to produce a positive electrode. The electrode material mixture to make the obtained positive electrode had a basis weight of 100 mg/cm², and an average density of 3.4 g/cm³. The produced positive electrode was punched out in 3 cm×4 cm and then used.

### [Production of Negative Electrode]

### (Production of Negative Electrode Material Mixture Slurry)

After mixing 96.5 mass % of natural graphite, 1 mass % of carbon black as a conductive additive, 1.5 mass % of styrene butadiene rubber (SBR) as a binding agent and 1 mass % of sodium carboxymethyl cellulose (CMC) as a thickening agent, the obtained mixture was dispersed in an appropriate amount of distilled water to produce negative electrode material mixture slurry.

### (Formation of Negative Electrode Material Mixture Layer)

Copper foil with a thickness of 8 mm was prepared as a negative electrode current collector. The negative electrode material mixture slurry was applied to the current collector using a die coater so that the coated amount was 45 mg/cm², and then dried at 120° C. for 12 hours under vacuum conditions. Next, the current collector having the formed negative electrode material mixture layer was roll-pressed at a pressure of 10 ton to produce a negative electrode. The electrode material mixture layer to make the obtained negative electrode had a basis weight of 45 mg/cm² and a density of 1.5 g/cm³. The produced negative electrode was punched out in 3 cm×4 cm and then used.

### [Production of Lithium Ion Secondary Battery]

A microporous film with a thickness of 25 mm, a three layer laminated body of polypropylene/polyethylene/polypropylene, was prepared as a separator, and was punched out in 3 cm×4 cm and then used. An aluminum laminate for secondary batteries was processed into the form of bag by sealing with heat. In the processed laminate, a laminated body, having the positive electrode, the negative electrode and the separator arranged therebetween, was then put to produce a laminate cell. Ethylene carbonate, dimethyl carbonate and ethyl methyl carbonate were mixed in a volume ratio of 3:4:3, and m the obtained solvent, 1.2 mol LiPFV. was dissolved to prepare a solution as an electrolyte solution. The electrolyte solution was injected into the laminate cell to produce a lithium ion secondary battery.

### Example 2

A battery was produced in the same manner as in Example 1 except that the positive electrode active material for the intermediate region had a median diameter (D50) of 3 mm, and the positive electrode active material for the surface regions had a median diameter (D50) of 10 mm.

### Comparative Example 1

A battery was produced in the same manner as in Example 1 except that only the positive electrode active material with a median diameter (D50) of 10 mm vas used, and the amount of the positive electrode active material in the mixture slurry was 94 mass %.

### <Evaluation of Initial Characteristics of Lithium Ion Secondary Battery>

The lithium ion secondary batteries in Examples 1 and 2 and Comparative Example 1 were evaluated about the following initial characteristics.

### [Initial Discharge Capacity]

A lithium ion secondary battery was allowed to stand at a measurement temperature (25° C.) for 3 hours, and constant current charge was then performed at 0.33 C until 4.2 V, and subsequently constant voltage charge was performed at a voltage of 4.2 V for 5 hours. Next, the lithium ion secondary battery was allowed to stand for 30 minutes, and then discharged at a discharge rate of 0.33 C until 2.5 V to measure a discharge capacity. The obtained discharge capacity was used as an initial discharge capacity.

### [Initial Cell Resistance]

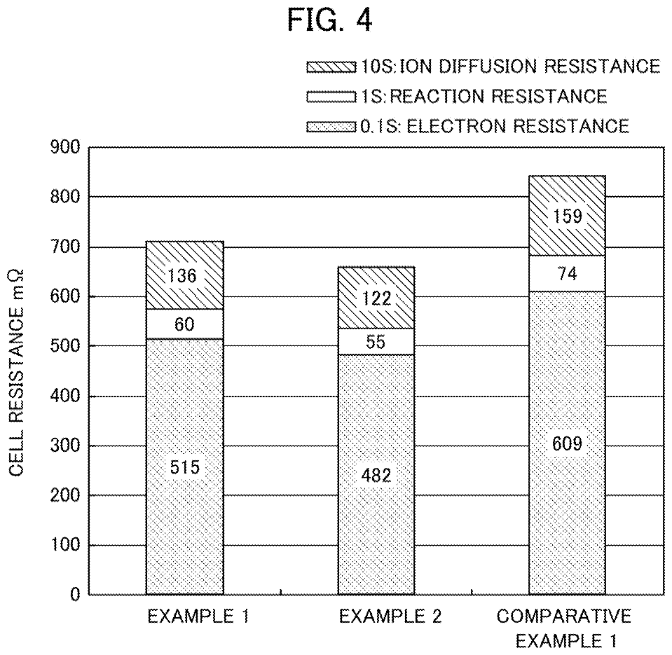

The lithium ion secondary battery after measuring the initial discharge capacity was adjusted to a SOC (state of charge) of 50%. Next, the battery was discharged at a current value of 0.2 C for 10 seconds, and the voltage was measured 10 seconds after completion of discharge. Next, after the lithium ion secondary battery was allowed to stand for 10 minutes, supplemental charge was performed to return the SOC to 50%, and the lithium ion secondary battery was allowed to stand for 10 minutes. Next, the above operations were performed at each C-rate, 0.5 C, 1 C, 1.5 C, 2 C and 2.5 C, and the results were plotted with current values along the abscissa and voltage along the ordinate. The slope cf the approximation straight line obtained from plots was used as the initial cell resistance of the lithium ion secondary battery. This result is shown in FIG. 4. As shown in FIG. 4, the cell resistance in Examples 1 and 2 is reduced compared to that in Comparative Example 1. In Examples 1 and 2, particularly, ion diffusion resistance is suppressed compared to that in Comparative Example 1, and the effect of the present invention can be understood.

### [C-Rate Characteristics]

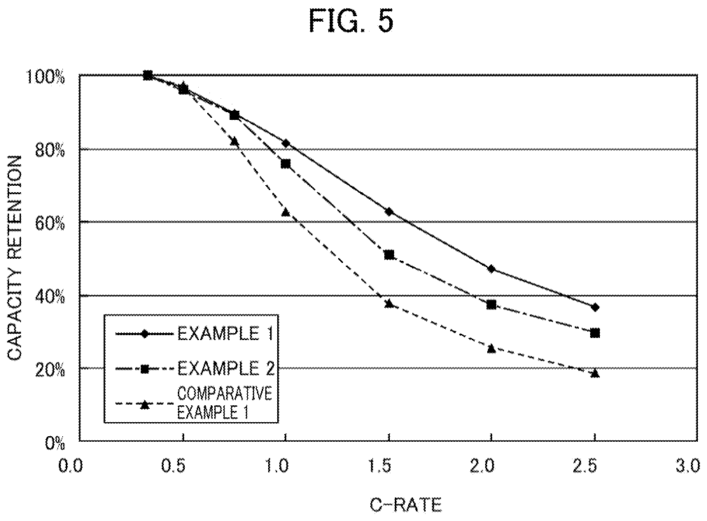

The lithium ion secondary battery after measuring the initial discharge capacity was allowed to stand at a measurement temperature (25° C.) for 3 hours, and constant current charge was then performed at 0.33 C until 4.2 V, and subsequently constant voltage charge was performed at a voltage of 4.2 V for 5 hours. Next, the lithium ion secondary battery was allowed to stand for 30 minutes, and then discharged at a discharge rate (C-rate) of 0.5 C until 2.5 V to measure an initial discharge capacity. The above operations were performed at each C-rate, 0.33 C, 1 C, 1.5 C, 2 C and 2.5 C, and the initial discharge capacity at each C-rate was converted to a capacity retention rate when the initial discharge capacity at 0.33 C was considered 100%, and this was used as C-rate characteristics. This result is shown in FIG. 5. As shown in FIG. 5, it can he understood that the volume retention rates in Examples 1 and 2 can be maintained higher than in Comparative Example 1.

### <Evaluation of Post-Durability Characteristics of Lithium Ion Secondary Battery>

The lithium ion secondary batteries in Examples 1 and 2 and Comparative Example 1 were evaluated about the following post-durability characteristics.

### [Post-Durability Discharge Capacity]

In a 45° C. constant temperature bath, constant current charge was performed to a lithium ion secondary battery at 0.6 C until 4.2 V, and subsequently constant voltage charge was performed at a voltage of 4.2 V for 5 hours or until obtaining a current value of 0.1 C. Next, the lithium ion secondary battery was allowed to stand for 30 minutes, constant current discharge was then performed at a discharge rate of 0.6 C until 2.5 V, and the battery was allowed to stand for 30 minutes. The operations were repeated 200 cycles. Next, in a 25° C. constant temperature bath, the lithium ion secondary battery was allowed to stand for 24 hours in the state after discharged until 2.5 V, end the post-durability discharge capacity was then measured in the same manner as in the initial discharge capacity. The operations were repeated every 200 cycles, and the post-durability discharge capacity was measured until 600 cycles.

### [Post-Durability Cell Resistance]

After completion of 600 cycles in the measurement of post-durability discharge capacity, the SOC (state of charge) was adjusted to 50%, and the post-durability cell resistance was found in the same manner as in the initial cell resistance.

### [Capacity Retention Rate]

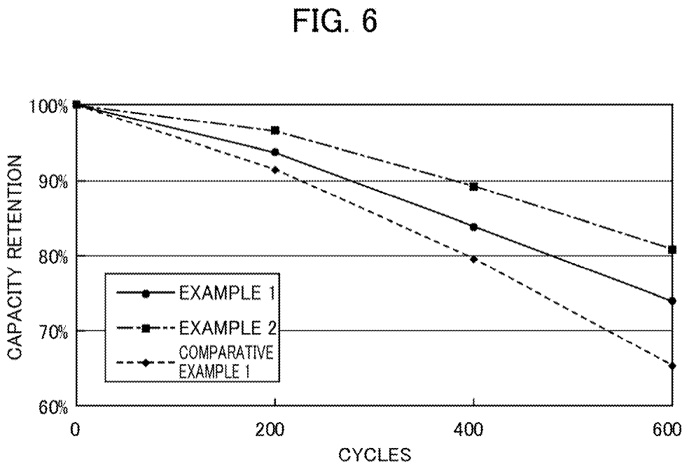

The ratio of post-durability discharge capacity every 200 cycles to the initial discharge capacity was found and used as a capacity retention rate in each cycle. This result is shown in FIG. 6. As shown in FIG. 6, it can be understood that the volume retention rates in Examples 1 and 2 can be maintained higher than in Comparative Example 1.

### [Resistance Change Rate]

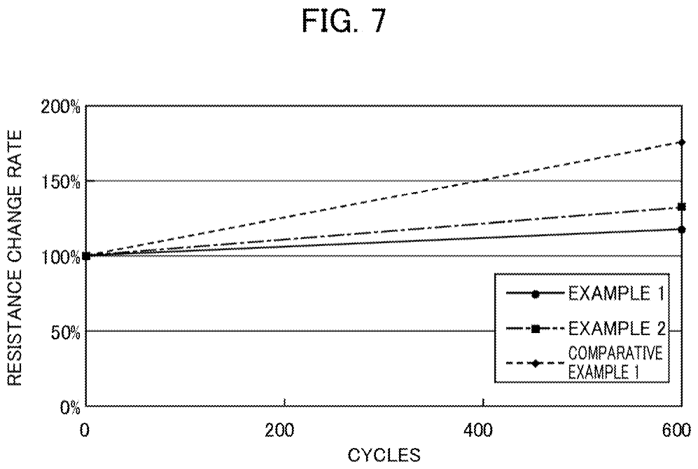

The ratio of post-durability cell resistance to the initial cell resistance was found and used as a resistance change rate. This result is shewn in FIG. 7. As shown in FIG. 7, it can be understood that the resistance change rates in Examples 1 and 2 can be maintained higher than in Comparative Example 1.

### EXPLANATION OF REFERENCE NUMERALS

10: Electrode for lithium ion secondary batteries

21: Positive electrode layer (electrode layer)

22: Positive electrode tab

25: Current collector (positive electrode)

25A: Surface region

25B: Intermediate region

25C: Surface region

26: Positive electrode active material

26a: First electrode active material

26b: Second electrode active material

27: Positive electrode material mixture

31: Negative electrode layer (electrode layer)

32: Negative electrode tab

35: Current collector (negative electrode)

35A: Surface region

35b: intermediate region

35C: Surface region

36: Negative electrode active material

36a: First electrode active material

36b: Second electrode active material

37: Negative electrode material mixture

41: Separator

50, 60: Die coater

50a, 60a: Plunger

What is claimed is:

1. An electrode for lithium Ion secondary batteries, the electrode comprising: a current collector made of porous metal; and an electrode layer comprising an electrode material mixture comprising at least an electrode active material, the current collector being filled with the electrode material mixture,
the current collector having an intermediate region and two surface regions in a thickness direction and in the electrode layer, the intermediate region having a porosity lower than that of the two surface regions,
the intermediate region being filled with a first electrode active material, the two surface regions being filled with a second electrode active material having a particle size larger than that of the first electrode active material.

2. The electrode for lithium ion secondary batteries according to claim 1, wherein the intermediate region has an electrode active material filling density higher than that of the two surface regions.

3. A lithium ion secondary battery, comprising a positive electrode, a negative electrode, and a separator or solid electrolyte layer located between the positive electrode and the negative electrode,
at least one of the positive electrode and the negative electrode being the electrode according to claim 1.

4. A method for producing an electrode for lithium ion secondary batteries, the method comprising:
a first step comprising forming a current collector that is made of porous metal and has an intermediate region and two surface regions in a thickness direction, wherein the intermediate region has a porosity lower than that of the two surface regions; and
a second step comprising filling the intermediate region of the current collector with an electrode material mixture comprising a first electrode active material and
filling the two surface regions of the current collector with an electrode material mixture comprising a second electrode active material having a particle size larger than of that of the first electrode active material.

5. The method for producing an electrode for lithium ion secondary batteries according to claim 4, wherein an electrode material mixture containing the first electrode active material and the second electrode active material is applied to each of sides of the two surface regions of the current collector and filled in the current collector.
